(19) United States
(12) Patent Application Publication
(10) Pub. No.: US 2014/0070469 A1
(43) Pub. Date: Mar. 13, 2014

(54) SUSPENSION SPRING FOR A REFRIGERATION COMPRESSOR

(71) Applicants: Claudio De Pellegrini, Joinville-Sc (BR); Carlos Eduardo Vendrami, Joinville-Sc (BR)

(72) Inventors: Claudio De Pellegrini, Joinville-Sc (BR); Carlos Eduardo Vendrami, Joinville-Sc (BR)

(73) Assignee: WHIRLPOOL S.A., Sao Paulo -Sp (BR)

(21) Appl. No.: 14/005,684

(22) PCT Filed: Mar. 16, 2012
(86) PCT No.: PCT/BR12/00071

§ 371 Date: Nov. 26, 2013

(30) Foreign Application Priority Data
Mar. 18, 2011 (BR) PI1101247-1

(51) Int. Cl. F16F 15/067; F04B 39/12

(52) U.S. Cl. CPC F16F 15/067; F04B 39/12
USPC 267/136

(57) ABSTRACT

Suspension spring for a refrigeration compressor of the type which comprises a shell and a block, forming, with the stator of an electric motor, a stationary assembly which is mounted in the interior of the shell by means of an assembly of helical springs. The helical spring presents, for a predetermined dimensional range of one of the spring parameters defined by the spring average diameter, the pitch of its coils, the spring wire diameter and the active height, a ratio between at least two of each pair of the other three parameters, defined to provide, to said helical suspension spring, for a desired frequency band, a stiffness corresponding, at minimum, to that of structural reliability of the suspension, and an attenuation in its acoustic transmissibility, in relation to the springs dimensioned only as a function of their suspension structural requirements for a desired frequency band.

### FIELD OF THE INVENTION

The present invention refers to a suspension spring to be used in a refrigeration compressor of the type which presents its motor-compressor assembly having a vertical crankshaft and being maintained suspended in the interior of a compressor shell, by means of helical springs operating under compression.

### PRIOR ART

Refrigeration compressors with a vertical shaft are conventionally provided with a spring suspension system, for attenuating the vibratory energy generated by the operation of the motor-compressor assembly in the frequency of the compressor operation, particularly by the reciprocating movement of the piston, and which is transmitted to the compressor shell; for limiting the movements of the motor-compressor assembly at the start and stop of the compressor; and for supporting the motor-compressor assembly during shipping.

The vibrations generated during the normal operation of the compressor are produced by the oscillation of the movable mass of the motor-compressor mechanical assembly, said movable mass usually comprising a piston, a connecting rod, and a crankshaft carrying the rotor of the electric motor of the compressor.

The suspension systems of the motor-compressor assembly can be divided into two groups: dampening with the use of springs working under distension and dampening with the use of springs working under compression.

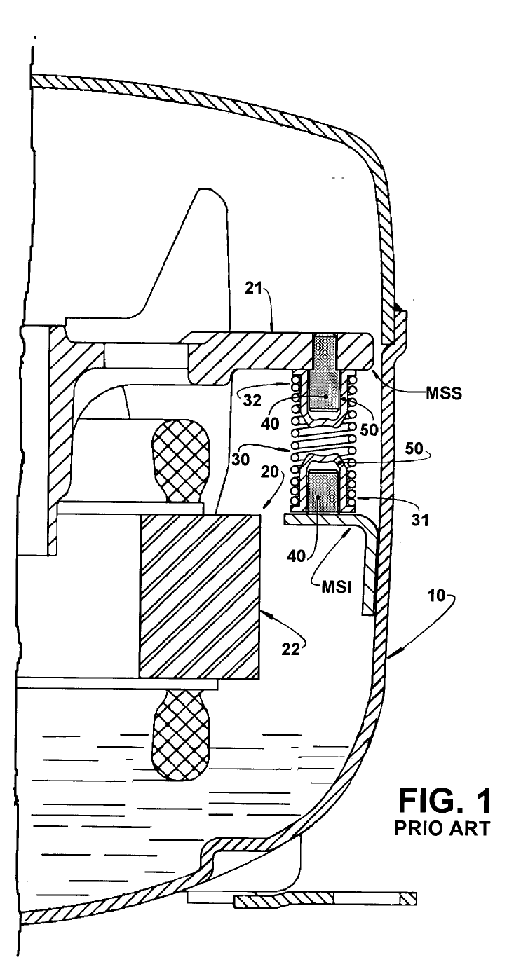

In the constructive arrangement using suspension springs working under compression, usually helical springs, as illustrated in FIG. 1 of the enclosed drawings, each helical spring 30 has a lower end 31 seated on an inferior support means MSI affixed to the compressor shell 10, in the interior thereof, and an upper end 32 seated on a superior support means MSS affixed to a stationary assembly 20 formed by the usual block 21 of the compressor and by the stator 22 of the respective electric motor.

The inferior support means MSI and superior support means MSS can be constructed in different known prior art manners, as long as they allow the motor-compressor assembly, including the block 21, to be maintained suspended in the interior of the shell 10, seated on four helical springs 30, each working under compression between an inferior support means MSI and a superior support means MSS.

According to a known technique for anchoring the helical springs 30 to the shell 10 and to the stationary assembly 20 of the compressor, each of the inferior support means MSI and superior support means MSS carries a respective pin 40. Each pin 40 can be machined or stamped, and affixed to the respective support means by welding or by any other adequate means.

Each pin 40 receives and retains, onto itself, a cover 50, generally made of synthetic material, as plastic or rubber, which covers the pin 40 and which is configured to be tightly fitted in the interior of the adjacent end of a respective helical spring 30 (FIG. 1). Said covers 50 define stops which limit the degree of compression of each respective helical spring 30, said covers being seated against each other, when the degree of compression of the helical spring 30 reaches a determined value.

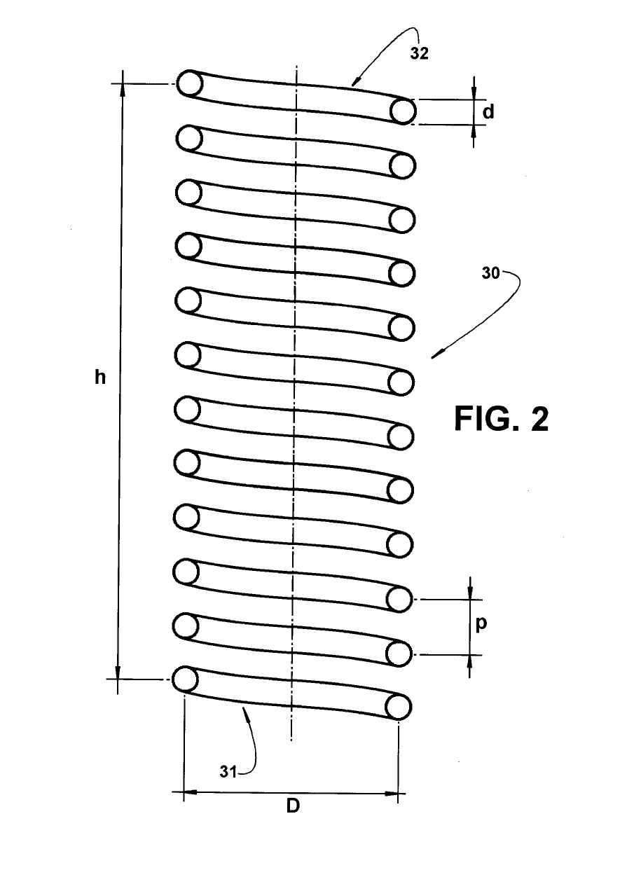

These known helical springs 30, as illustrated in FIG. 2, present its active height h (disregarding the inactive coils, which interfere with the respective covers), the wire diameter d, the spring average diameter D and the pitch p (between the coils) dimensioned so that the spring geometry is compatible with the mounting space available in the interior of the compressor shell and with the adequate static stiffness for the spring. Said dimensioning, aiming at determining the static stiffness of the spring, takes into account two limits which should be respected. The stiffness should not be too high, otherwise it would not be possible to reduce the vibration transmission from the compressor to the associated refrigeration system (for example, a refrigerator), mainly in the operating frequency of the compressor and in its first harmonic. On the other hand, the stiffness of the spring should not be too low, at the risk of allowing the motor-compressor assembly, including the block 21, to hit the shell 10 upon the start or stop of the compressor, or even upon abrupt movements during shipping operations.

However, the so far developed springs are not able to effectively reduce the vibratory energy transmitted to the refrigeration system, with which the compressor is physically associated, in frequencies above the operating frequencies of the compressor. In other words, the known springs are not designed to reduce the transmission of noise to the outside of the compressor, presenting a high structural transmissibility (the amount of force the spring transmits from one end, by the unitary displacement in the other end) in determined spectrum regions, causing an undesirable production of noise, upon application of the compressor in a refrigeration appliance.

Therefore, it is desirable to search for a spring of the type considered herein, but which also presents a significant reduction in the acoustic transmissibility through its structure, in a desired frequency band, for example, in the band of ⅓ octave at 1600 Hz.

### SUMMARY OF THE INVENTION

Due to the limitations mentioned above and related to the characteristics of a helical spring for suspension of a compressor, the invention has the object of providing a suspension spring for a refrigeration compressor which operates, in an adequate manner, as a suspension element for the motor-compressor assembly, and also as an element for reducing the transmission of vibration from the compressor to the structures physically associated therewith.

These and other objects are attained through a suspension spring to be applied in a refrigeration compressor of the type which comprises a shell and a block forming, with the stator of an electric motor, a stationary assembly which is mounted in the interior of the shell, by means of a suspension including an assembly of helical springs, each spring presenting a lower end and an upper end, each end being coupled, respectively, to an adjacent part of the shell and of the stationary assembly.

According to the invention, the suspension spring presents, for a predetermined dimensional range of one of the spring parameters defined by the spring average diameter, the coil pitch, the wire diameter and the active height of the spring, a ratio between at least two of each pair of the other three parameters, defined to provide, to said suspension spring, a stiffness corresponding, at minimum, to that of the structural reliability of the suspension, and an attenuation in its acoustic transmissibility, in relation to the springs dimensioned only as a function of their suspension structural requirements for a desired frequency band.

Generally, the spring parameter which presents a predetermined dimensional range is the spring wire diameter, the ratios between the other parameters being defined by the ratio between the spring diameter and the pitch of its coils and by the ratio between the spring diameter and its active height.

In a more specific manner, the suspension spring of the present invention presents, for a predetermined range of spring wire diameters defined between 1.3 mm and 1.7 mm, a relation between the spring diameter and the pitch of its coils varying between 4.9 and 7.85, and a relation between the spring diameter and its active height between 0.81 and 0.90, in order to provide an attenuation in the spring acoustic transmissibility up to, approximately, 30 dB.

The reduction in the acoustic transmissibility of the spring can reach 30 dB, by optimizing the parameters (that is, the spring diameter D, the wire diameter d, the pitch p and the active height h) selected for the spring. The best spring provides a reduction of transmissibility of 30 dB at the band of 1600 Hz in relation to the worst spring (the reference spring of the compressor is among the worst springs for this band; the optimized spring is among the best ones).

The construction proposed by the invention, and defined above, allows for a reduction in the dynamic stiffness of the spring and for an attenuation in the acoustic transmissibility, providing a reduction of about 6 dB in the sound power level radiated by the compressor, in the band of ⅓ octave at 1600 Hz.

Comparing a specific compressor having an optimized spring, with a compressor having a reference spring (a bad spring for the region of 1600 Hz), it is observed a reduction of 6 dB (A) in the noise of the compressor, for the band of 1600 Hz.

### BRIEF DESCRIPTION OF THE INVENTION

The invention will be described below, with reference to the enclosed drawings in which:

FIG. 1 represents a schematic vertical sectional view of a portion of a refrigeration compressor, illustrating a part of the stationary assembly, including the block and the stator and having a helical suspension spring mounted according to the prior art;

FIG. 2 represents a diametrical longitudinal sectional view of a helical spring dimensioned according to the present invention;

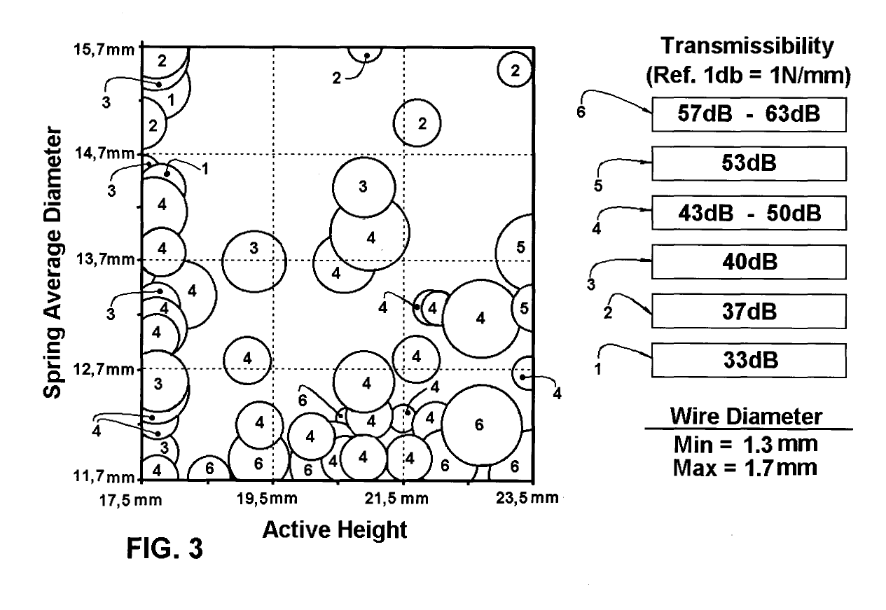

FIG. 3 represents a diagram with the x-axis representing the effective spring heights (in mm), with the y-axis representing the spring average diameter (in mm), with the circle radiuses representing the spring wire diameters, varying between 1.3 mm and 1.7 mm, and with the numerical reference of the circles representing the degrees of transmissibility of the spring (the smaller number represents the lower degree of transmissibility), as presented in the figure legend;

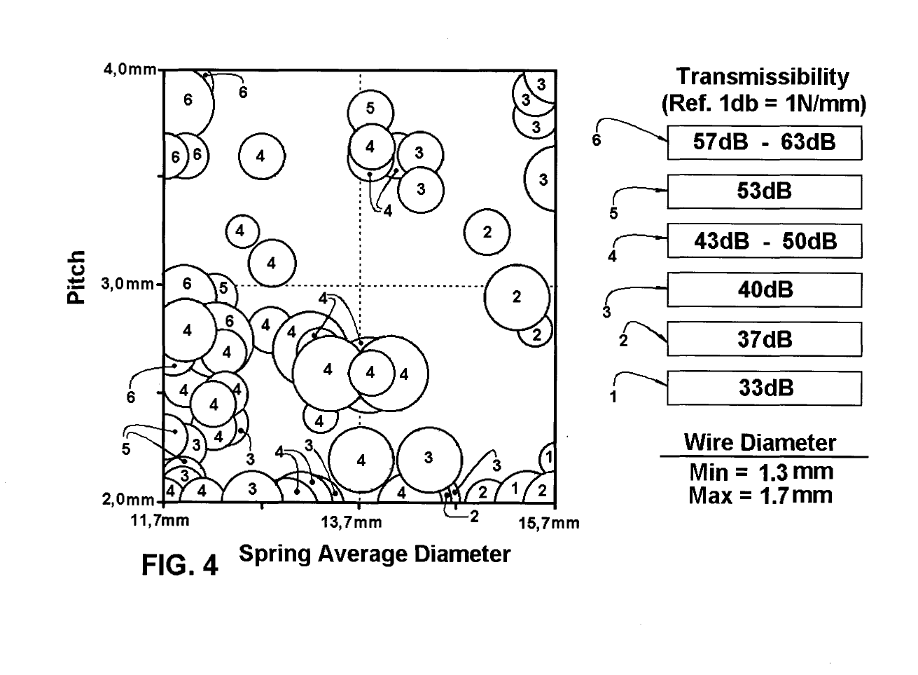

FIG. 4 represents a diagram with the x-axis representing the spring diameters (in mm), with the y-axis representing the pitch (in mm) of the spring coils, with the circle radiuses representing the spring wire diameters, varying between 1.3 mm and 1.7 mm, and with the numerical reference of the circles representing the degrees of transmissibility of the spring (the smaller number represents the lower degree of transmissibility), as presented in the figure legend; and

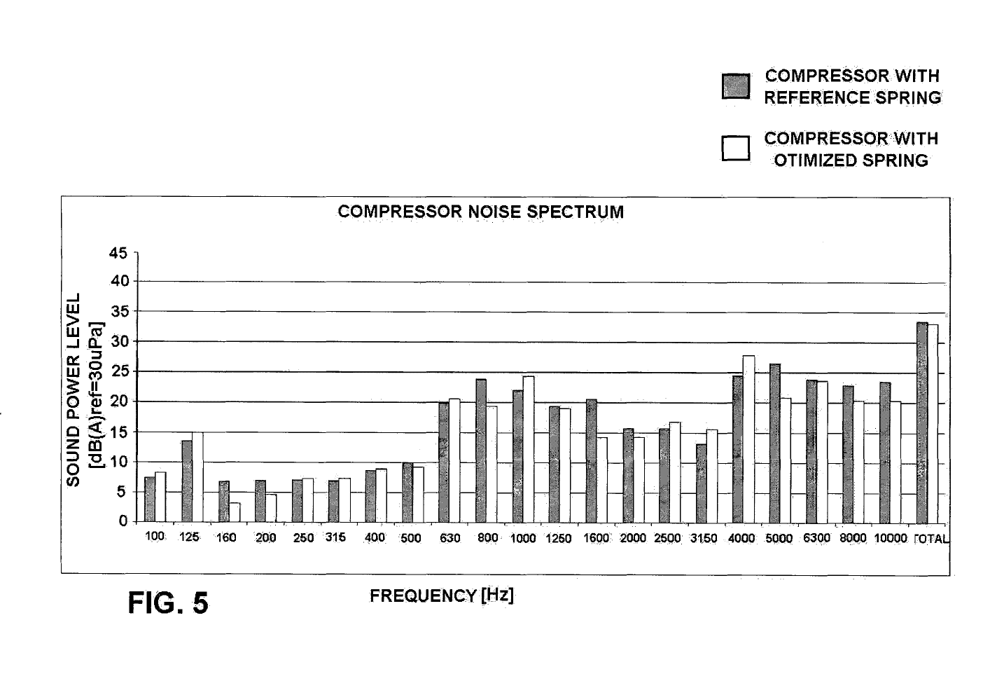

FIG. 5 represents a graph with the x-axis representing frequencies (in Hz) and, the y-axis, the sound power level (in dB), with the columns indicating the noise spectrum of the compressor, for a compressor using a conventional reference spring (left gray columns) and a compressor using a spring obtained according to the present invention (right white columns).

### DESCRIPTION OF THE INVENTION

As illustrated and already previously described, the helical spring, obtained according to the present invention, is applied to a refrigeration compressor of the vertical shaft type and which comprises, as illustrated in FIG. 1, a stationary assembly 20 formed by a block 21, to which is affixed a stator 22 of an electric motor of the compressor. The stationary assembly 20 is mounted in the interior of a shell 10, by means of a suspension system including helical springs 30, working under compression, each spring presenting a lower end 31 and an upper end 32 and only one of said springs being illustrated in FIG. 1. The helical spring has its lower end 31 and its upper end 32 coupled, respectively, to an adjacent part of shell 10 and of stationary assembly 20. According to the invention, the helical suspension spring 30 presents, for a predetermined dimensional range of one of the spring parameters defined by the spring average diameter D, the coil pitch p, the wire diameter d and the active height h of the spring, a ratio between at least two of each pair of the other three parameters, defined to provide, to said helical suspension spring 30, a stiffness corresponding, at minimum, to that of the structural reliability of the suspension, and an attenuation in its acoustic transmissibility, in relation to the springs dimensioned only as a function of their suspension structural requirements for a desired frequency band.

In the construction of the present invention, the spring parameter which presents predetermined dimensional range is the spring wire diameter d, the ratios between the other parameters being defined by the ratio between the spring diameter D and the pitch p of its coils and by the ratio between the spring diameter D and its active height h.

In a more specific manner, the suspension spring of the present invention presents, for a predetermined range of spring wire diameters d, defined between 1.3 mm and 1.7 mm, a relation between the spring diameter D and the pitch p of its coils varying between 4.9 and 7.85 and a relation between the spring diameter D and its active height h between 0.81 and 0.90, so as to provide an attenuation in the acoustic transmissibility of 6 dB in sound power level radiated by the compressor, in the band of ⅓ octave at 1600 Hz.

In order to define the helical spring 30 of the present invention, the maximum and minimum limits for the optimized dimensional parameters of said helical spring 30 are the following:

The active height has its upper limit defined by the minimum distance the compressor assembly should have in relation to the shell 1, in order to avoid impact therebetween during the operation of the compressor. The lower limit of the active height h is defined in order to avoid impacts, during the compressor operation, between the stops which, in the example of FIG. 1, are defined by the covers 50.

The helical spring 30 is constructed with a circular section wire, generally in spring steel and presenting a wire diameter d with its upper and lower limits defined so that the spring presents, neither a too high stiffness, nor a low fatigue strength.

The spring average diameter D has its upper and lower limits usually defined by the diameter of the stop (cover 50 in FIG. 1) and by the wire diameter d.

In determined situations, when there is freedom to re-design the stop, usually the upper limit of the spring average diameter D is defined as a diameter which provides a minimum distance of the spring in relation to the coil head of the stator 22.

In the case of the parameter defined by the pitch p between the coils, said pitch may have its upper and lower limits defined so that the spring has neither a too high or a too low stiffness, nor a great facility for spring blocking (when the active coils touch each other and their compression process starts).

In an exemplary construction of the present invention, the helical spring 30 should present, for a predetermined range of spring wire (or thread) diameters d, defined by the maximum and minimum values of 1.3 mm and 1.7 mm in the diagrams of FIGS. 3 and 4, a relation between the spring average diameter D and the pitch p of its coils varying between 4.9 and 7.85, and a relation between the spring average diameter D and its active height h between 0.81 and 0.90.

The diagrams of FIGS. 3 and 4 show that the helical springs 30, considered in the exemplified spring construction and which present a lower degree of transmissibility, are those which present the dimensional relations indicated above.

In the embodiments of the present invention, represented in FIGS. 3 and 4 and commented above, it is possible to obtain, as a function of the correct selection of the spring parameters, a reduction of the values of transmissibility from 63 dB to values around 33 dB, for the springs represented by the numbers 6 and 1, respectively, in said figures, considering 1 N/mm as reference for the calculation in dB, passing by values of 53 dB, 43 dB to 50 dB, 40 dB and 37 dB for the springs represented by the numbers 5 to 2, respectively, in the same FIGS. 3 and 4.

Thus, the spring construction proposed by the invention allows obtaining an attenuation of acoustic transmissibility of the spring of up to about 30 dB. As already previously mentioned, this degree of attenuation in the transmissibility of the spring allows obtaining an attenuation in the sound power level radiated by the compressor of about 6 dB in the band of ⅓ octave at 1600 Hz.

From these relations between the parameters, the helical spring 30 of the present invention may have its maximum dimensions geometrically optimized by any appropriate methodology which considers the parameters of active height h, spring wire diameter d, spring average diameter D and pitch p between the spring coils.

For better defining the helical spring 30, there are also considered the following parameters: infinite fatigue life; axial stiffness and transverse stiffness, as restrictions; transmissibility in a determined spectrum region; using simulation of rigid bodies to determine vibration of the compressor assembly and the tension suffered by the spring in a real operating condition, considering the presence of the stops; and experimental validation through the test of spring transmissibility, experimental vibration measurement of the compressor assembly and noise test (measurement of sound power level, radiated by a compressor in a reverberant chamber).

The present process also considers the harmonic analysis with transmissibility calculation and fatigue analysis with safety factor calculation for the suspension function of the spring, the safety factor for infinite life being calculated from at least two tensions to which the spring is submitted.

The process of obtention has the object of minimizing a sum of axial and transversal transmissibilities in relation to the longitudinal axis of the helical spring, in a desired noise frequency produced by the compressor. The obtained helical spring should present a determined stiffness, which should remain within a range which ensures the spring to be neither excessively stiff, nor flexible to the point of making the compressor assembly hit against the shell 10, and only submitted to tension levels which can ensure infinite life for the spring.

According to the present invention, the stiffness and noise dampening conditions, to be presented by a determined helical spring 30, are defined by ratios between the parameters of spring wire diameter d and pitch p, active height h and spring average diameter D, which are able to produce the effects of transmissibility attenuation, as already mentioned above.

In a particular constructive example of the present invention, a helical spring, for suspension of a refrigeration compressor of the type defined above, which presents minimization of a sum of axial and transversal transmissibilities in relation to the longitudinal axis of the helical spring, in the band of ⅓ octave at 1600 Hz, should have its average diameter D of 14.7 mm to 15.7 mm, the wire diameter d between 1.3 mm and 1.7 mm, and the pitch p between its coils of about 2 mm to 3 mm. For said frequency band, this helical spring should present a useful or active height h of 17.5 mm to 18.0 mm.

FIG. 5 represents, for the particular constructive example of the helical spring cited above, the noise reduction provided, in the band of 1600 Hz, for a specific compressor. According to FIG. 5, in most of the evaluated frequencies (which generate the noise of the compressor) from 100 Hz to 10,000 Hz, there occurs an increase in the attenuation of the sound power level, said attenuation being more pronounced at 1600 Hz (of 6 dB).

1. A suspension spring for a refrigeration compressor of the type which comprises a shell and a block forming, with the stator of an electric motor, a stationary assembly which is mounted in the interior of the shell by means of a suspension including an assembly of helical springs, each spring presenting a lower end and an upper end, each said end being coupled, respectively, to an adjacent part of shell and of stationary assembly, said helical spring being characterized in that it presents, for a predetermined dimensional range of one of the spring parameters defined by the spring average diameter, the pitch of its coils, the spring wire diameter and the active height, a ratio between at least two of each pair of the other three parameters, defined to provide, to said helical suspension spring, for a desired frequency band, a stiffness corresponding, at minimum, to that of the structural reliability of the suspension, and an attenuation in its acoustic transmissibility, in relation to the springs dimensioned only as a function of their suspension structural requirements for a desired frequency band.

2. The suspension spring, as set forth in claim 1, characterized in that it presents, for a predetermined range of spring wire diameters, a ratio between the spring average diameter and the pitch of its coils and a ratio between the spring average diameter and its active height, defined to provide, to said helical spring, a stiffness corresponding, at minimum, to that of structural reliability of the suspension, and an attenuation in the acoustic transmissibility, in relation to the springs dimensioned only as a function of their suspension structural requirements.

3. The suspension spring, as set forth in claim 2, characterized in that it presents, for a predetermined range of spring wire diameters, defined between 1.3 mm and 1.7 mm, a relation between the spring diameter and the pitch of its coils varying between 4.9 and 7.85 and a relation between the spring diameter and its active height between 0.81 and 0.90, in order to provide an attenuation in the acoustic transmissibility of the spring of up to about 30 dB.

4. The suspension spring, as set forth in claim 3, characterized in that the spring wire diameter is from 1.3 mm to 1.7 mm, the pitch is from 2 mm to 3 mm, the spring average diameter is from 14.7 mm to 15.7 mm and the spring active height is from 17.5 mm to 18.0 mm, attenuating, in 6 dB, the sound power level radiated by the compressor, in the band of ⅓ octave at 1600 Hz.
